(19) United States
(12) Patent Application Publication
(10) Pub. No.: US 2021/0008708 A1
(43) Pub. Date: Jan. 14, 2021

(54) HOLDER FOR REPLACEABLE PART OF A TOOL

(71) Applicant: STANLEY BLACK & DECKER MEA FZE, Dubai (AE)

(72) Inventor: Julien BAYLE, Besancon (FR)

(21) Appl. No.: 16/979,468

(22) PCT Filed: Feb. 20, 2019
(86) PCT No.: PCT/EP2019/054211

§ 371 Date: Sep. 9, 2020

(30) Foreign Application Priority Data
Mar. 9, 2018 (EP) 18160967.8

(51) Int. Cl. B25H 3/00; B25B 7/04; B25H 3/02

(52) U.S. Cl. CPC B25H 3/003; B25H 3/02; B25B 7/04

(57) ABSTRACT

The invention deals with a holder (22, 23) for holding a replaceable part (1) of a tool, such as a replaceable jaw of pliers, wherein the replaceable part (1) comprises a first locking member (6), and wherein the tool further comprises a handle (3) comprising a second locking member (8), wherein one of the first and second locking members (6, 8) is moveable relative to the other locking member between: ° an engaged position wherein the second locking member (8) is engaged with the first locking member (6) so as to lock the replaceable part (1) to the handle (3), and ° a disengaged position wherein the second locking member (8) is disengaged from the first locking member (6) so as to allow the replaceable part (1) and the handle (3) to be separated, wherein the holder (22, 23) comprises a cavity (32) for receiving the replaceable part (1), and an unlocking member (36) adapted to move said one of the first and second locking members (6, 8) from the engaged position to the disengaged position when the replaceable part (1) is received in the cavity (32).

### FIELD OF THE INVENTION

The invention deals with a holder for holding a replaceable part of a tool, such as a replaceable jaw of pliers.

### STATE OF THE ART

A conventional tool, such as a pair of pliers, comprises handles and replaceable jaws which can be releasably locked to the handles. Since different jaws can be alternatively locked to the same handles, the tool is customisable.

It is also known a box for storing the handles and different pairs of jaws lockable to the handles.

A user can form the customisable tool by: pulling the handles out of the box, pulling a first jaw out the box, engaging a first locking member of the handles with a second locking member of the replaceable jaw so as to lock the first jaw to the handles, pulling a second jaw out of the box, engaging a third locking member of the handles with a fourth locking member of the second jaw so as to lock the second jaw to the handles.

After using the customisable tool, a user has to carry out the following steps: disengaging the first and second locking members, then separating the first jaw from the handles, disengaging the third and fourth locking members, then separating the second jaw from the handles, putting the handles in the box, putting the first jaw in the box, putting the second jaw in the box.

However, the number of manipulations the user has to perform for storing the tool in the box after use is high.

### SUMMARY OF THE INVENTION

The purpose of the invention is to reduce the number of manipulations a user has to perform for storing a customisable tool after use.

For this purpose, it is proposed a holder for holding a replaceable part of a tool, such as a replaceable jaw of pliers, wherein the replaceable part comprises a first locking member, and wherein the tool further comprises a handle comprising a second locking member, wherein one of the first and second locking members is moveable relative to the other locking member between:
an engaged position wherein the second locking member is engaged with the first locking member so as to lock the replaceable part to the handle, and
a disengaged position wherein the second locking member is disengaged from the first locking member so as to allow the replaceable part and the handle to be separated,
   wherein the holder comprises a cavity for receiving the replaceable part, and an unlocking member adapted to move said one of the first and second locking members from the engaged position to the disengaged position when the replaceable part is received in the cavity.

The holder may further comprise the following features taken alone or in combination whenever it makes sense.

The unlocking member may be arranged to be moveable relative to a wall of the holder defining the cavity between:
a first position wherein the unlocking member is disengaged from the said one of the first and second locking members,
a second position wherein the unlocking member is engaged with the said one of the first and second locking members so as to disengage the second locking member from the first locking member and allow the handle to be separated from the replaceable part.

The unlocking member may further be arranged such that:
in the first position, the unlocking member allows the replaceable part to enter or exit the cavity,
in the second position, the unlocking member retains the replaceable part in the cavity.

The holder may comprise a resilient member for urging the unlocking member towards the first position.

The holder may comprise a first wall and a second wall defining the cavity therebetween, wherein one of the first and second walls is arranged to be urged by a user towards the other wall so as to move the unlocking member into the second position when the replaceable part is received in the cavity.

The holder may comprise retaining means, different from the unlocking member, for retaining the replaceable part in the cavity.

The holder may comprise a third wall joining the first wall to the second wall, wherein the retaining means comprises a protrusion protruding from the third wall in the cavity so as to be engaged in a recess of the replaceable part, when the replaceable part is received in the cavity.

The unlocking member may comprise a finger protruding in the cavity and arranged to be engaged in a hole of the first locking member so as to push the second locking member out of the hole and disengage the second locking member from the first locking member.

The finger may also be arranged to retain the replaceable part in the cavity when the finger is engaged in the hole.

The holder may further be adapted to hold a second replaceable part of the tool, such as a second replaceable jaw of pliers, wherein the second replaceable part comprising a third locking member, wherein the tool further comprises a second handle comprises a fourth locking member, wherein one of the third and fourth locking members is moveable relative to the other locking member between:
an engaged position wherein the fourth locking member is engaged with the third locking member so as to lock the second replaceable part to the second handle, and
a disengaged position wherein the fourth locking member is disengaged from the third locking member so as to allow the second replaceable part and the second handle to be separated,
   wherein the holder comprises a second unlocking member adapted to move said one of the third and fourth locking members from the engaged position to the disengaged position when the first and second replaceable parts are both received in the cavity.

The second unlocking member may be also arranged to be moveable relative to a wall defining the cavity between:
a first position wherein the second unlocking member is disengaged from the said one of the third and fourth locking members,
a second position wherein the second unlocking member is engaged with the said one of the third and fourth locking member so as to disengage the fourth locking member from the third locking member and allow the second handle to be separated from the second replaceable part.

The second unlocking member may further be arranged such that:
in the first position, the unlocking member allows the second replaceable part to enter or exit the cavity,
in the second position, the second unlocking member retains the second replaceable part in the cavity.

The holder may comprise a first wall and a second wall defining the cavity therebetween, wherein the first wall comprises the unlocking member, and the second wall comprises the second unlocking member.

The holder may comprise second retaining means, different from the second unlocking member, for retaining the second replaceable part in the cavity.

The holder may comprise a fourth wall joining the first wall to the second wall, wherein the third and fourth wall define the cavity therebetween, and the second retaining means comprises a protrusion protruding from the fourth wall in the cavity so as to be engaged in a recess of the second replaceable part, when both replaceable parts are received in the cavity.

The second unlocking member may comprise a second finger protruding in the cavity and arranged to be engaged in a second hole of the third locking member so as to push the fourth locking member out of the second hole and disengage the fourth locking member from the third locking member.

The second finger may also be arranged to retain the second replaceable part in the cavity when the second finger is engaged in the second hole.

It is also proposed a kit comprising:
a replaceable part of a tool, wherein the replaceable part comprises a first locking member, and wherein the tool further comprises a handle comprising a second locking member, wherein one of the first and second locking members is moveable relative to the other locking member between:
   an engaged position wherein the second locking member is engaged with the first locking member so as to lock the replaceable part to the handle, and
   a disengaged position wherein the second locking member is disengaged from the first locking member so as to allow the replaceable part and the handle to be separated,
the holder described above.

The kit may further comprise:
a handle comprising a second locking member, wherein one of the first and second locking members is moveable between:
   an engaged position wherein the second locking member is engaged with the first locking member so as to lock the replaceable part to the handle, and
   a disengaged position wherein the second locking member is disengaged from the first locking member so as to allow the replaceable part and the handle to be separated.

The handle may comprise a resilient member for urging the second locking member towards the engaged position.

The kit may further comprise a storage box comprising a first compartment for storing the holder while the replaceable part is received in the cavity of the holder, and a second compartment for storing the handle.

The storage box may comprise a cover moveable between:
an opened position allowing the holder to be inserted in the storage box,
a closed position wherein the cover retains the holder in the storage box,
   wherein the storage box is arranged so as to allow the first and second locking member to be engaged with each other while the holder is in the first compartment and the replaceable part is received in the cavity of the holder.

The storage box may have a through opening arranged to define an access to the cavity of the holder from the exterior of the storage box, such that the first and second locking member can be engaged with each other while: the holder is stored in the first compartment, the replaceable part is received in the cavity of the holder, and the cover is in the closed position.

### DESCRIPTION OF THE FIGURES

Further details, features and advantages of the invention are explained in more detail below with the aid of the exemplary embodiments of the invention that are illustrated in the figures in which:

FIG. 1 is a side view of separated parts of a customisable tool, according to an embodiment of the invention.

FIG. 2 is a side view of the parts illustrated in FIG. 1 locked together.

FIG. 3 is another side view of the separated parts illustrated in FIG. 1.

FIG. 4 is another side view of the locked parts illustrated in FIG. 2.

FIGS. 5 and 6 are a view in perspective and a front view, respectively, of a holder according to a first embodiment of the invention.

FIGS. 5 and 6 are a view in perspective and a front view, respectively, of a holder according to a first embodiment of the invention.

FIG. 7 is a view in perspective of a holder according to a second embodiment of the invention.

FIG. 8 is a view in perspective of a kit comprising a box, the holder according to the second embodiment and the parts illustrated in FIG. 1.

FIG. 9, 10, 11 are front views of the holder according to the first embodiments in use. Similar features have identical numbers in all figures.

### DETAILED DESCRIPTION OF AT LEAST ONE EMBODIMENT

a) Description of a Pair of Pliers

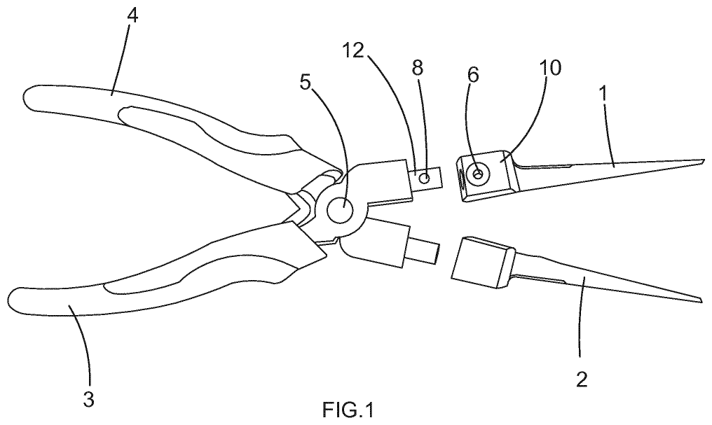

Referring to FIG. 1, a pair of pliers comprises a first replaceable jaw 1, a second replaceable jaw 2, a first handle 3, and a second handle 4.

The second handle 4 is pivotally mounted on the first handle 3, for instance by means of a pivot 5.

The first jaw 1 comprises a first locking member 6, and the first handle 3 comprises a second locking member 8.

One of the first and second locking members 6 or 8 is moveable relative to the other locking member 8 or 6 between an engaged position wherein the second locking member 8 is engaged with the first locking member 6 so as to lock the first jaw 1 to the first handle 3, and a disengaged position wherein the second locking member 8 is disengaged from the first locking member 6 so as to allow the first jaw 1 and the first handle 3 to be separated.

The first jaw 1 comprises a female end portion 10 defining an opened inner cavity. The female end portion 10 comprises a wall having a hole opening in the inner cavity and opening outside the first jaw 1. The first locking member 6 is formed by said hole. Therefore, the hole of the first jaw 1 is referred to as hole 6 hereinafter.

The first handle 3 comprises a male end portion 12 adapted to be received in the cavity of the female end portion 10. The male end portion 12 has for instance the form of a cylindrical stem.

The second locking member 8 is moveable between a retracted position wherein it is retracted in the male end portion 12, and a deployed position wherein its protrudes from the male end portion 12.

The first handle 3 comprises a resilient member (not shown), such as a spring, for urging the second locking member 8 towards the deployed position. Thus, the resilient member and the second locking member 8 can form a spring-loaded ball.

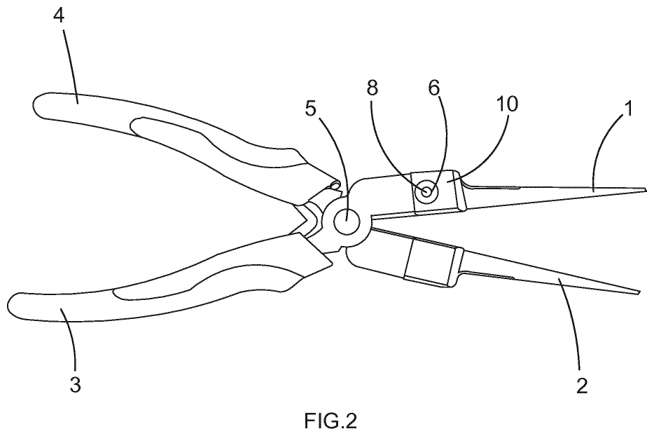

The second locking member 8 is arranged such that, when the male end portion 12 is received in the inner cavity defined by the female end portion 10, the second locking member 8 can be engaged in the hole in its deployed position, so as to lock the first jaw 1 to the first handle 3, as illustrated in FIG. 2. In other words, in the engaged position, the second locking member 8 is in the deployed position relative to the male end portion 12 of the first handle 3.

Moving the second locking member 8 in the retracted position allows the male end portion 12 to exit the inner cavity defined in the female end portion 10, thus allows the first handle 3 and the first jaw 1 to be separated.

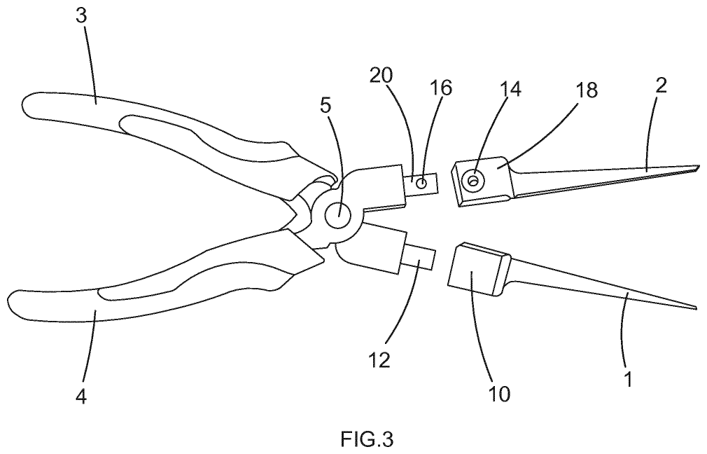

Referring to FIG. 3, the second jaw 2 comprises a third locking member 14, and the second handle 4 comprises a fourth locking member 16.

One of the third and fourth locking members 14 or 16 is moveable relative to the other locking member 16 or 14 between an engaged position wherein the fourth locking member 16 is engaged with the third locking member 14 so as to lock the second jaw 2 to the second handle 4, and a disengaged position wherein the fourth locking member 16 is disengaged from the third locking member 14 so as to allow the second jaw 2 and the second handle 4 to be separated.

The second jaw 2 comprises a female end portion 18 defining an opened inner cavity. The female end portion 18 comprises a wall having a hole opening in the inner cavity and opening outside the second jaw 2. The third locking member 14 is formed by said hole. Therefore, the hole of the second jaw 2 is referred to as hole 14 hereinafter.

The second handle 4 comprises a male end portion 20 adapted to be received in the cavity of the female end portion 18. The male end portion 20 has for instance the form of a cylindrical stem.

The fourth locking member 16 is moveable between a retracted position wherein it is retracted in the male end portion 20, and a deployed position wherein its protrudes from the male end portion 20.

The second handle 4 comprises a resilient member (not shown), such as a spring, for urging the fourth locking member 16 towards the deployed position. Thus, the resilient member and the second locking member 8 can form a spring-loaded ball.

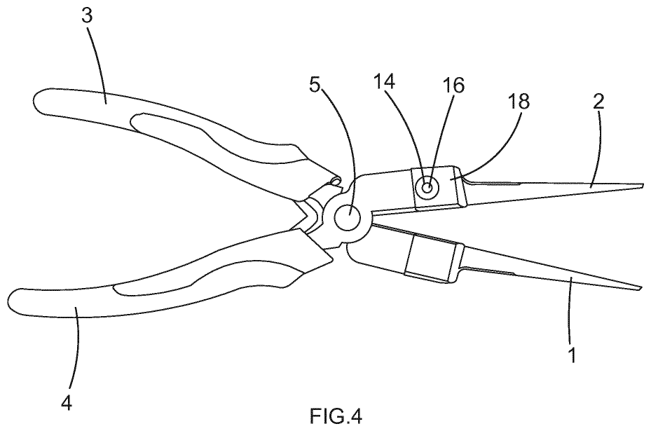

The fourth locking member 16 is arranged such that, when the male end portion 20 is received in the inner cavity defined by the female end portion 18, the fourth locking member 16 can be engaged in the hole in its deployed position, so as to lock the second jaw 2 to the second handle 4 as illustrated in FIG. 4. In other words, in the engaged position, the fourth locking member 16 is in the deployed position relative to the male end portion 20 of the second handle 4.

Moving the fourth locking member 16 in the retracted position allows the male end portion 20 to exit the inner cavity defined by the female end portion 18, thus allows the second handle 4 and the second jaw 2 to be separated.

The second and fourth locking member 8, 16 are arranged on the handles to protrudes in two opposite directions, for instance directions that are parallel to a rotation axis of the second handle 4 relative to the first handle 3.

The first and second jaws 1, 2 are different pieces. They are for instance perfectly identical in the embodiment of FIGS. 1 to 4. In such embodiment, the second jaw 2 can also be locked to the first handle 3, and the first jaw 1 can also be locked to the second handle 4.

b) Description of Holders for Holding a Pair of Jaws

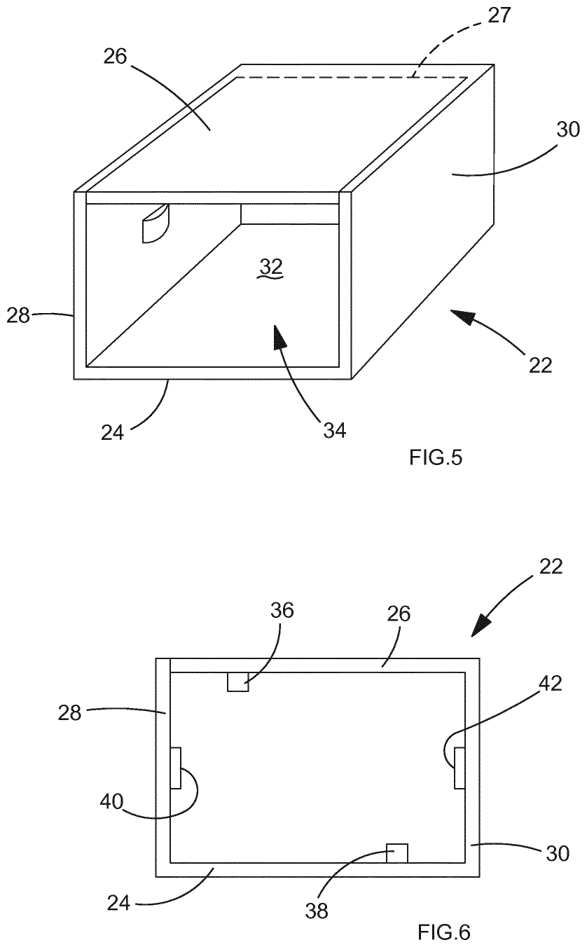

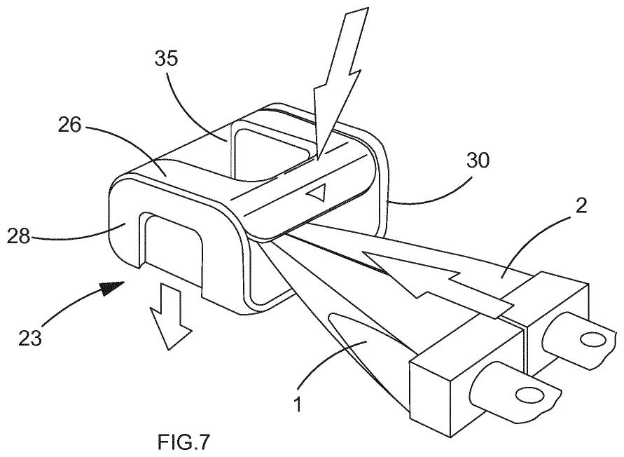

Now referring to FIGS. 5 and 6, a holder 22 for holding the first jaw 1 comprises a bottom wall 24, a top wall 26, a first side wall 28, and a second side wall 30.

Walls 24, 26, 28, and 30 are joined together to define a cavity 32 therebetween for receiving at least one of the two jaws 1, 2, preferably for receiving the two jaws 1, 2 simultaneously.

The holder 22 has a front opening 34 giving an access to the cavity 32 from the exterior of the holder 22. The opening 34 is arranged between the bottom wall 24 and the top wall 26, and between the two side walls 28, 30. The two jaws 1, 2 can be inserted in the cavity 32 via the front opening 34.

The holder 22 comprises a first unlocking member 36 adapted to move one of the first and second locking members 6, 8 from the engaged position to the disengaged position when the first jaw 1 is received in the cavity 32.

The first unlocking member 36 is also arranged to be moveable relative to the bottom wall 24 between a first position wherein the first unlocking member 36 is disengaged from the first locking member 6, and a second position wherein the first unlocking member 36 is engaged with the first locking member 8, so as to disengage the second locking member 8 from the first locking member 6 and allow the first handle 3 to be separated from the first jaw 1.

The first unlocking member 36 is arranged on the top wall 26.

The first unlocking member 36 comprises a finger protruding in the cavity 32 from the top wall 26. The finger is arranged to be engaged in the hole defining the first locking member 6, so as to push the second locking member 6 out of the hole and disengage the second locking member 8 from the first locking member 6.

The first unlocking member 36 is closer to the first side wall 28 than to the second side wall 30. The finger is substantially parallel to the first side wall 28.

The holder 22 comprises a resilient member for urging the first unlocking member 36 towards the first position. The resilient member is for instance the top wall 26 itself or a part thereof, such that the top wall 26 forms a tongue which can be flexed about the dashed line 27 illustrated in FIG. 5. The top wall 26 can be moved closer to the bottom wall 24 when it is pressed by the hand of user.

Besides, the holder 22 comprises a second unlocking member 38 adapted to move one of the third and fourth locking members 14, 16 from the engaged position to the disengaged position when the second jaw 2 is received in the cavity 32.

The second unlocking member 38 is also arranged to be moveable relative to the top wall 26 between a first position wherein the second unlocking member 38 is disengaged from the third locking member 14, and a second position wherein the second unlocking member 38 is engaged with the third second locking member 8, so as to disengage the fourth locking member 16 from the third locking member 14 and allow the second handle 4 to be separated from the second jaw 2.

The second unlocking member 38 is arranged on the bottom wall 24.

The second unlocking member 38 comprises a finger protruding in the cavity 32 from the bottom wall 24. The finger is arranged to be engaged in the hole 14 defining the third locking member, so as to push the fourth locking member 16 out of the hole and disengage the fourth locking member 16 from the third locking member 14.

The second unlocking member 38 is closer to the second side wall 30 than to the first side wall 28. The finger is substantially parallel to the second side wall.

The first and second unlocking members 36, 38 protrude in the cavity 32 in two opposite directions, since there are located on the top wall 26 and the bottom wall 24 respectively. However, the first and second unlocking members 36, 38 are arranged to face the two holes 6, 14 respectively, when the two jaws 1, 2 are simultaneously received in the cavity 32 of the holder 22. whereas the second unlocking member 38 is closer to the second side wall than to the second side wall 30.

Besides, the holder 22 comprises first retaining means, different from the first unlocking member 36, for retaining the first jaw 1 in the cavity 32. The first retaining means comprises a first protrusion 40 protruding from the first side wall 28 in the cavity 32 so as to be engaged in a recess of the first jaw 1, when the first jaw 1 is received in the cavity 32. The first protrusion 40 has a curved free surface, to smoothen the engagement of the first protrusion into said recess.

The holder 22 further comprises second retaining means, different from the second unlocking member 38, for retaining the second jaw 2 in the cavity 32. The second retaining means comprises a second protrusion 42 protruding from the second side wall 30 in the cavity 32 so as to be engaged in a recess of the second jaw 2, when the second jaw 2 is received in the cavity 32. The second protrusion 42 has a curved free surface, to smoothen the engagement of the second protrusion into the corresponding recess.

The first and second protrusions 40, 42 protrude in the cavity 32 in two opposite directions, since there are located on the second side wall 30 28 and the second side wall respectively. The two protrusions 40, 42 face each other, such that the two jaws 1, 2 can be retained in the cavity 32 between the two protrusions 40, 42.

Referring to FIG. 7, a holder 23 according to a second embodiment comprises all features described above in relation with FIGS. 5 and 6. However, in the second embodiment, the holder comprises a back opening 35 opposite to the front opening 34 with respect to the cavity 32. The back opening may also extend in the top wall 26, in which case top wall 26 has a U-shape. When the jaws 1, 2 are received in the cavity 32, portions of the jaws may extend through the back opening 35 and outside the holder. In other words, in the present application, the expression “jaws received in the cavity” encompasses jaws at least partially received in the cavity.

c) Description of a Storage Box for Storing Handles and Holders Holding Jaws

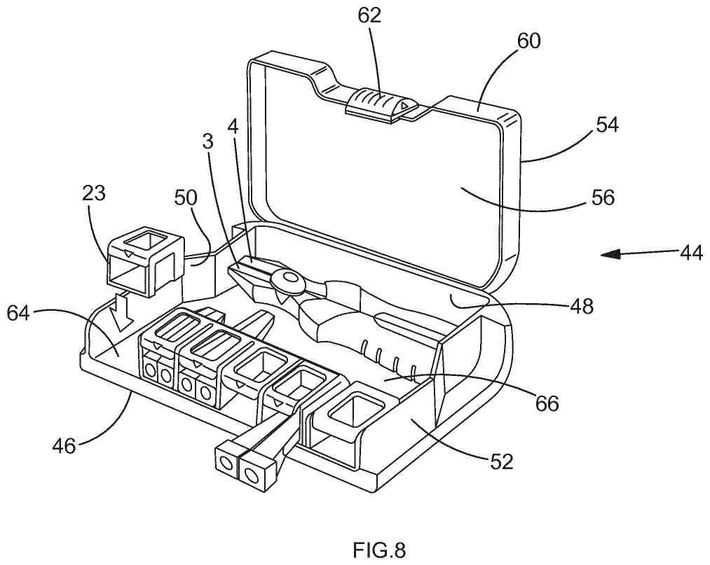

Now referring to FIG. 8, a storage box 44 comprises a bottom wall 46, a back wall 48, two side walls 50, 52.

The storage box 44 defines a cavity for storing the handles 3, 4 and many holders holding pairs of jaws, such as jaws 1, 2. This cavity is arranged between the two side walls 50, 52.

The storage box 44 further comprises a cover 54 moveable between an opened position and a closed position.

The cover 54 comprises a top wall 56 and a front wall 60.

The cover 54 is rotatably mounted on the back wall 48. For instance, the top wall 56 is pivotally mounted on the back wall 48 by means of a hinge (not shown).

When the cover 54 is in the opened position, the handles 3, 4 and many holders 22 or 23 holding pairs of jaws, such as jaws 1, 2, can be simultaneously stored in the cavity.

When the cover 54 is in the closed position, the cavity is between the bottom wall 44 and the top wall 56, and between the front wall 60 and the back wall 48. In the closed position, the cover retains the handles and the holders 22 stored in the cavity of the box 44.

The box 44 further comprises a latch locking mechanism 62 for locking the cover 54 in the closed position. The latch locking mechanism is mounted on the front wall 60.

The bottom wall 46 defines at least one first compartment 64 for storing holders 22, and a second compartment 66 for storing the handles 3, 4. In the embodiment depicted in FIG. 8, six holders can be stored in a single first compartment 64, so as to be aligned in a row, next to the front wall for example when the cover 54 is closed.

The storage box 44 comprise first stops (not shown) arranged to prevent a plurality of holders stored in the first compartment 64 to move along the bottom wall 46, thus retaining said plurality of holders in the first compartment 64.

For instance, the first stops comprise the side walls 50, 52. In this case, the width of the first compartment 64 may be chosen such that when the second compartment 66 is full of holders 22, the holders stored in the second compartment 66 cannot move towards any of the two side walls 50, 52. The first stops may also comprise additional protrusions protruding from the bottom wall and arranged to prevent a holder stored in the first compartment 64 to move closer to or away from the back wall 48.

The compartment for storing the handles is located between the first compartment 64 and the back wall.

The box 44 is arranged such that, when the cover is in the opened position, the front opening of a holder 22 stored in the first compartment 64 is accessible from the exterior of the box, such that jaws 1, 2 can be inserted in the holder 22 without having to move the holder 22 out of the box.

In the embodiment of FIG. 8, this arrangement is obtained by locating the first compartment 64 next to the front wall 60, and by including the front wall 60 in the cover 54.

In an alternate embodiment, front wall 60 may have at least on from opening between the exterior of the box 44 and its cavity. Such front opening defines an access to the cavity of the holder 22 from outside the storage box 44, more precisely defines an access to the first compartment 64. Thus, jaws 1, 2 can be inserted in the holder 22 without having to open the box.

d) Use of the Holders and the Storage Box for Storing Handles and Jaws

Suppose that the first and second jaws 1, 2 are locked to the handles, so as to form a customisable pair of pliers.

After using the pliers, a user call carries out the following steps.

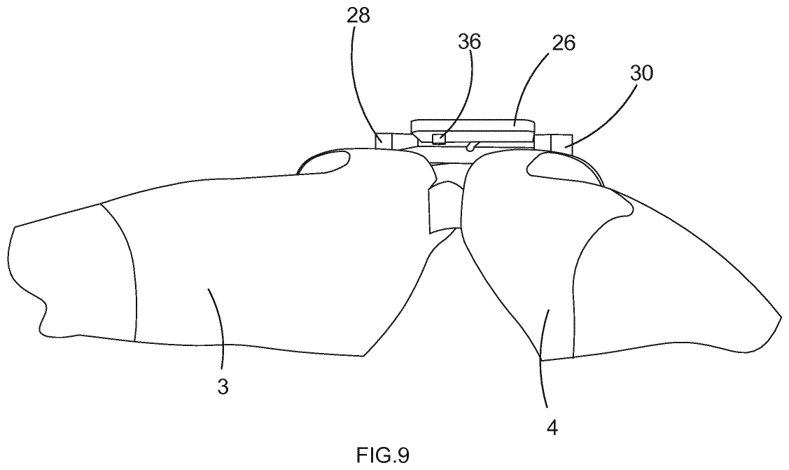

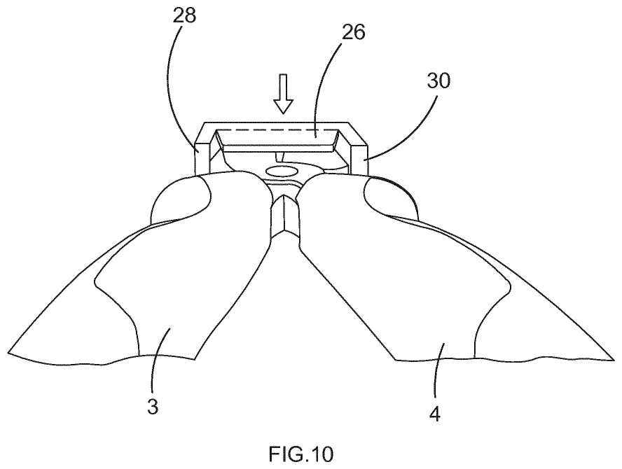

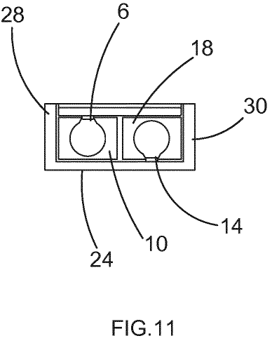

First the user seizes the holder 22 in one hand and seizes the handles of the pliers in another hand. As shown in FIG. 9, the user brings the jaws 1, 2 in the cavity of the holder 22, until the jaws 1, 2 reaches a position relative to the holder 22 wherein the first protrusion protruding from the first side wall engages in a recess of the first jaw 1 and the second protrusion protruding from the second side wall engages in a recess of the second jaw 2s. In the very same position, the first hole faces the first finger protruding from the top wall and the second hole faces the second finger protruding from the bottom wall.

The first and second protrusions prevent the jaws 1, 2 from falling outside the cavity defined in the holder 22.

Then, the user squeezes the holder 22 so as to move the top wall towards the bottom wall, as indicated by the arrow drawn in FIG. 10.

Moving the top wall towards the bottom wall urges the first finger in the first hole. In other words, the first unlocking member 36 reaches the second position wherein it is engaged with the first locking member 6. In the second position, the first unlocking member 36 retains the first jaw 1 in the cavity.

When the first finger enters the first hole, the first fingers pushes the spring-loaded ball outside the hole, such that the spring-loaded ball is retracted within the male end portion of the first handle 3. In other words, the first unlocking member 36 moves the second locking member 8 in the disengaged position, so as to allow the first handle 3 and the first jaw 1 to be separated.

Besides, moving the top wall towards the bottom wall urges the second finger in the second hole. In other words, the second unlocking member 38 reaches the second position wherein it is engaged with the third locking member 14. In the second position, the second unlocking member 38 retains the second jaw 2 in the cavity.

When the second finger enters the second hole, the seconds fingers pushes the spring-loaded ball outside the second hole, such that the spring-loaded ball is retracted within the male end portion of the second handle 4. In other words, the second unlocking member 38 moves the fourth locking member 16 in the disengaged position, so as to allow the first handle 3 and the first jaw 1 to be separated.

In one single action performed by the user (squeezing the holder 22), both jaws 1, 2 are unlocked from the handles.

When the user moves the handles away from the holder 22 while maintaining the top wall close to the bottom wall, such that the first and second fingers remain engaged in the first and second holes 6, 14, respectively, the male end portions 12, 20 of the handles 3, 4 get out of the female end portions 10, 18 of the jaws 1, 2. Since the jaws 1, 2 are both retained in the cavity 32 be means of the two fingers engaged in the holes 6, 14, this separation is made easier. FIG. 11 shows the jaws 1, 2 retained in the cavity 32 of the holder 22 after this separation.

When the user stops squeezing the holder 22, the resilient member urges the top wall 26 away from the bottom wall 24, thereby moves the first finger 36 out of the first hole of the first jaw 1. In other words, the first unlocking member 36 stops retaining the first jaw 1 in the cavity 32 of the holder 22. Nonetheless, the first jaw 1 is still retained in the cavity 32 by means of the first protrusion protruding 40 from the first side wall 28.

When the user stops squeezing the holder 22, the second finger 38 may remain engaged in the hole of the second jaw 2 under the effect of gravity. If the second finger 38 ever leaves the hole of the second jaw 2, for instance because the holder 22 is turned upside down, the second jaw 2 is still retained in the cavity by means of the second protrusion 42 protruding from the second side wall 30.

After opening the storage box 44, the user then places the holder 22 (and the jaws 1, 2 held in the holder 22) in the first compartment 64 defined in the box 44. The user also places the handles 3, 4, now separated from the jaws 1, 2, in the second compartment 66.

Then, the user moves the cover 60 in the closed position so as to close the box 44 and retain the holder 22 and the handles 3, 4 in their respective compartments 64, 66.

Alternatively, all steps above are advantageously carried out while the holder 22 is in the first compartment 64, such that the bottom wall 24 of the holder 22 rests on the bottom wall 46 of the box 44. If the box 44 comprises a front opening, the holder 22 is oriented such that the front opening of the holder 22 is aligned with the front opening of the box 44.

The user first inserts the jaws 1, 2 through the front opening of the box 44 giving an access to the first compartment 64 wherein the (empty) holder 22 is stored, or moves the cover into the opened position if the box does not comprise such front opening, so as to make said compartment accessible.

Then, the user inserts the jaws 1, 2 locked to the handles 3, 4 in the cavity 32 defined in the holder 22 via the front opening of the holder 22. During this step, the user may use one hand to maintain the holder 22 in the first compartment 64 if the cover 60 has been opened, i.e. does not retain anymore the holder 22 in the first compartment 64.

Rather than squeezing the holder 22 with two fingers, the user can also press on the top wall of the holder 22 so as to move it towards the bottom wall of the holder 22 resting on the bottom wall 46 of the box 44.

e) Forming a Customisable Tool from the Content Stored in the Box

The user carries out the following steps to form a customisable tool from the handles and the jaws 1, 2 stored in the storage box 44.

First, the user opens the box 44. The user then grabs the handles 3, 4 stored in the second compartment 66 with one hand and pulls them out of the box 44. At this stage, the front opening (if any) giving access to the jaws 1, 2 received in the holder 22 is accessible.

Then, the user inserts the male end portions 12, 20 of the two handles 3, 4 in the two female end portions 10, 18 of the jaws 1, 2 received in the holder 22 stored in the first compartment 64 of the box 44. During this insertion, the top and bottom walls 24, 26 of the holder 22 urge the spring-loaded balls 8, 16 in their retracted positions. When the male end portions 12, 20 reach a predetermined position relative to the female end portions 10, 18 of the jaws 1, 2, both spring-loaded balls 8, 16 are aligned with the two holes 6, 14 defined in the female end portions 10, 18 of the jaws 1, 2. In this predetermined position, the spring-loaded balls 8, 16 naturally engage in the holes 6, 14, under the urging effect of their resilient member. At this stage, the handles 3, 4 are locked to the jaws 1, 2, thereby forming a pair of pliers.

When the user pulls the handles 3, 4 away from the holder 22, the jaws 1, 2 locked to the handles 3, 4 also exit the cavity 32. In this step, the user exerts a pulling force sufficient to cause the first and second protrusions 40, 42 protruding from the two side walls 28, 30 of the holder 22 to leave the recesses of the jaws 1, 2 wherein said protrusions were engaged so far.

The pair of pliers is now ready to use.

It can be noted that multiple holders 22 containing different pairs of jaws 1, 2 may be simultaneously stored in the box 44. The steps described above can be carried out by a user wanting to replace the first and second jaws 1, 2 locked to the handles 3, 4 by another pair of jaws received in another holder stored in the box 44.

Of course, the invention is not limited to the embodiments described above. It can be generalised to any tool comprises at least one handle and at least one replaceable part.

1. Holder (22, 23) for holding a replaceable part (1) of a tool, such as a replaceable jaw of pliers, wherein the replaceable part (1) comprises a first locking member (6), and wherein the tool further comprises a handle (3) comprising a second locking member (8), wherein one of the first and second locking members (6, 8) is moveable relative to the other locking member between:
an engaged position wherein the second locking member (8) is engaged with the first locking member (6) so as to lock the replaceable part (1) to the handle (3), and
a disengaged position wherein the second locking member (8) is disengaged from the first locking member (6) so as to allow the replaceable part (1) and the handle (3) to be separated,
wherein the holder (22, 23) comprises a cavity (32) for receiving the replaceable part (1), and an unlocking member (36) adapted to move said one of the first and second locking members (6, 8) from the engaged position to the disengaged position when the replaceable part (1) is received in the cavity (32).

2. Holder (22, 23) according to claim 1, comprising a bottom wall (24), top wall (28), first side wall (28) and second side wall (30) defining the cavity (32), and wherein the unlocking member (36) is also arranged to be moveable relative to the wall between:
a first position wherein the unlocking member (36) is disengaged from the said one of the first and second locking members (6, 8),
a second position wherein the unlocking member (36) is engaged with the said one of the first and second locking members (6, 8) so as to disengage the second locking member (8) from the first locking member (6) and allow the handle (3) to be separated from the replaceable part (1).

3. Holder (22, 23) according to claim 2, wherein the unlocking member (36) is further arranged such that:
in the first position, the unlocking member (36) allows the replaceable part (1) to enter or exit the cavity (32),
in the second position, the unlocking member (36) retains the replaceable part (1) in the cavity (32).

4. Holder (22, 23) according to one of claims 2 and 3, comprising a resilient member for urging the unlocking member (36) towards the first position.

5. Holder (22, 23) according to any of claims 2 to 4, further comprising a first wall (26) and a second wall (24) defining the cavity (32) therebetween, wherein one of the first and second walls (24, 26) is arranged to be urged by a user towards the other wall so as to move the unlocking member (36) into the second position when the replaceable part (1) is received in the cavity (32).

6. Holder (22, 23) according to any of the preceding claims, further comprising retaining means (40), different from the unlocking member (36), for retaining the replaceable part (1) in the cavity (32).

7. Holder (22, 23) according to claims 5 and 6 in combination, comprising a third wall (28) joining the first wall to the second wall (24, 26), wherein the retaining means (40) comprises a protrusion protruding from the third wall in the cavity (32) so as to be engaged in a recess of the replaceable part (1), when the replaceable part (1) is received in the cavity (32).

8. Holder (22, 23) according to any of the preceding claims, wherein the unlocking member (36) comprises a finger protruding in the cavity (32) and arranged to be engaged in a hole of the first locking member (6) so as to push the second locking member (8) out of the hole and disengage the second locking member (8) from the first locking member (6).

9. Holder (22, 23) according to claim 8, wherein the finger is also arranged to retain the replaceable part (1) in the cavity (32) when the finger is engaged in the hole.

10. Kit comprising:
a replaceable part (1) of a tool, wherein the replaceable part (1) comprises a first locking member (6), and wherein the tool further comprises a handle (3) comprising a second locking member (8), wherein one of the first and second locking members (6, 8) is moveable relative to the other locking member between:
an engaged position wherein the second locking member (8) is engaged with the first locking member (6) so as to lock the replaceable part (1) to the handle (3), and
a disengaged position wherein the second locking member (8) is disengaged from the first locking member (6) so as to allow the replaceable part (1) and the handle (3) to be separated,
a holder (22, 23) according to any of the preceding claims for holding the replaceable part (1).

11. Kit according to claim 10, further comprising:
a handle (3) comprising a second locking member (8), wherein one of the first and second locking members (6, 8) is moveable between:
an engaged position wherein the second locking member (8) is engaged with the first locking member (6) so as to lock the replaceable part (1) to the handle (3), and
a disengaged position wherein the second locking member (8) is disengaged from the first locking member (6) so as to allow the replaceable part (1) and the handle (3) to be separated.

12. Kit according to any of claims 10 and 11, wherein the handle (3) comprises a resilient member for urging the second locking member (8) towards the engaged position.

13. Kit according to any of claims 10 to 12, further comprising a storage box (44) comprising a first compartment (64) for storing the holder (22, 23) while the replaceable part (1) is received in the cavity (32) of the holder (22, 23), and a second compartment (66) for storing the handle (3).

14. Kit according to claim 13, wherein the storage box (44) comprises a cover (54) moveable between:
an opened position allowing the holder (22, 23) to be inserted in the storage box (44),
a closed position wherein the cover retains the holder (22, 23) in the storage box (44), wherein the storage box (44) is arranged so as to allow the first and second locking member (6, 8) to be engaged with each other while the holder (22, 23) is in the first compartment (64) and the replaceable part (1) is received in the cavity (32) of the holder (22, 23).

15. Kit according to claim 14, wherein the storage box (44) has a through opening arranged to define an access to the cavity (32) of the holder (22, 23) from the exterior of the storage box (44), such that the first and second locking member (6, 8) can be engaged with each other while: the holder (22, 23) is stored in the first compartment (64), the replaceable part (1) is received in the cavity of the holder (22, 23), and the cover is in the closed position.
